(19) United States
(12) Patent Application Publication
(10) Pub. No.: US 2017/0327432 A1
(43) Pub. Date: Nov. 16, 2017

(54) COMPOSTER AND COMPOSTING SYSTEM

(71) Applicant: MAZE DISTRIBUTION PTY LTD, CLAYTON (AU)

(72) Inventor: RONEN MAZOR, CLAYTON (AU)

(21) Appl. No.: 15/582,805

(22) Filed: May 1, 2017

(30) Foreign Application Priority Data
May 2, 2016 (AU) 2016901613

(51) Int. Cl. C05F 17/02

(52) U.S. Cl. CPC C05F 17/0258; C05F 17/0205; C05F 17/0211

(57) ABSTRACT

A composting apparatus having a composting receptacle that is adapted to hold biodegradable matter until the matter turns into compost in the receptacle, the composting receptacle having at least one aperture through which the biodegradable matter is able to be either inserted into or removed from the composting receptacle, the composting receptacle adapted to rotate about an axis of rotation.

### FIELD

The invention relates to composting apparatus.

### BACKGROUND

Composters are used to hold an amount of biodegradable matter, such as vegetable scraps and garden waste, for a sufficient length of time until the matter turns into compost.

There are a number of problems or disadvantages in the prior art of such composters, and an object of the invention is to overcome or at least ameliorate one or more of the problems in the prior art, or to at least provide an improved alternative.

Nothing in this specification should be construed as an admission of the state of common general knowledge of the skilled addressee.

The references herein to and descriptions of prior proposals or products are not intended to be, and are not to be construed as, statements or admissions of common general knowledge in the art. In particular, any prior art discussion herein does not relate to what is commonly or well known by the person skilled in the art, but assists in the understanding of the inventive step of the invention of which the identification of pertinent prior art proposals is but one part.

### SUMMARY

According to the invention, there is provided a composting apparatus comprising:

a composting receptacle adapted to hold biodegradable matter until the matter turns into compost in the receptacle,

the composting receptacle having at least one aperture through which the biodegradable matter is able to be either inserted into or removed from the composting receptacle;

the composting receptacle adapted to rotate about an axis of rotation.

Preferably, the composting receptacle is provided with one or more material-transit apertures through which the degradable matter is able to be either inserted into and removed from the composting receptacle as compost, and wherein each of said one or more one material-transit apertures is provided with a retractable sliding cover.

Preferably, the composting receptacle has an interior chamber that is able to be divided into sub-chambers using chamber-divider-means to divide the interior chamber.

Preferably, the composting receptacle is divided into at least two interior chambers, and the sliding cover is able to be slid away part of the way to reveal only one of the sub-chambers, with the other sub-chamber being sealed by the other portion of the sliding cover.

Preferably, the composting receptacle is provided with a gear system that enables the rotation motion of the composting receptacle.

Preferably, the gear system is operable by a hand-operated crank.

Preferably, the gear system is adapted to be installed on the composting apparatus being originally a gearless apparatus such that the composting apparatus is able to function and rotate with said gear system installed.

Preferably, composting receptacle is provided with one or more air-transit apertures through which air is able to be enter the composting receptacle.

Preferably, the apparatus is provided with a bag-support mechanism for holding a bag that can accept waste material.

Preferably, the composting receptacle is provided with a stand that is adapted to hold the composting receptacle a distance above ground, and the composting apparatus is further provided with a compost-transporter that is sized to fit in the space below the composting receptacle in said distance between the composting receptacle and the ground such that, in use, compost removed from the composting receptacle is able to fall directly into the compost-transporter positioned therebelow.

According to another aspect of the invention, there is provided a composting system comprising a composting apparatus described above, and a compost-transporter of such dimensions that the compost-transporter is adapted to fit in a gap that is underneath the composting receptacle when supported on a stand such that, in use, compost removed from the composting receptacle is able to fall directly into the compost-transporter positioned therebelow.

### BRIEF DESCRIPTION OF THE DRAWINGS

In order that the invention might be more fully understood, embodiments of the invention will be described, by way of example only, with reference to the accompanying drawings. Possible features of the present features of the invention will be described as examples only, however, it is to be understood that the features illustrated in and described with reference to the drawings are not to be construed as limiting on the scope of the invention. In the drawings:

FIG. 1A is a perspective view of an embodiment of a composting apparatus;

FIG. 1B is a conceptual and schematic diagram of the embodiment of FIG. 1A, with this drawing rendered so as to show certain hidden parts of a gear system that are hidden from view in the realistic representation of FIG. 1A;

FIG. 2A is a front view of the embodiment of FIG. 1A shown in one particular orientation, bearing in mind that the barrel is able to rotate;

FIG. 2B is a rear view of the orientation of FIG. 1A, bearing in mind that the barrel is able to rotate;

FIG. 2C is a top view of the orientation of FIG. 1A, bearing in mind that the barrel is able to rotate;

FIG. 3A shows the embodiment of FIG. 1A with its sliding door partially slid across to reveal the underlying door-aperture;

FIG. 3B shows the embodiment of FIG. 3A with the sliding door having been completely removed to reveal the full door-aperture;

FIG. 3C is a top view of the embodiment of FIG. 3B;

FIG. 4 is an exploded view which shows the embodiment of FIG. 1A with an internal partition that is adapted to divide the interior chamber of the barrel;

FIG. 5A shows an end view of the embodiment of FIG. 1A, at the end that has a rotational handle;

FIG. 5B shows the other end view of the embodiment of FIG. 1A, at the end that does not have the rotational handle;

FIG. 6 shows an exploded view of the embodiment of FIG. 1A, showing components that can be added to the barrel so as to combine to enable the handle to impart rotation to the barrel;

FIG. 7 shows another embodiment of a composting apparatus having two door-apertures, where each of the door-apertures has a sliding door;

FIG. 8A shows a perspective view of an embodiment of a trolley that is adapted to be used in combination with the composter illustrated in FIG. 1A;

FIG. 8B is a view of the embodiment of FIG. 5B, shown here with the trolley of FIG. 8A used in combination with the composter illustrated in FIGS. 1A and 5B;

FIG. 9A is a perspective view of another embodiment of a composting apparatus having a modified stand assembly; and

FIG. 9B shows an end view of the embodiment of FIG. 9A, at the end that has a rotational handle, and showing the end view of the modified stand assembly.

In the different embodiments, like components are labeled with like reference numerals merely for the sake of ease of understanding the different embodiments and modifications.

### DETAILED DESCRIPTION

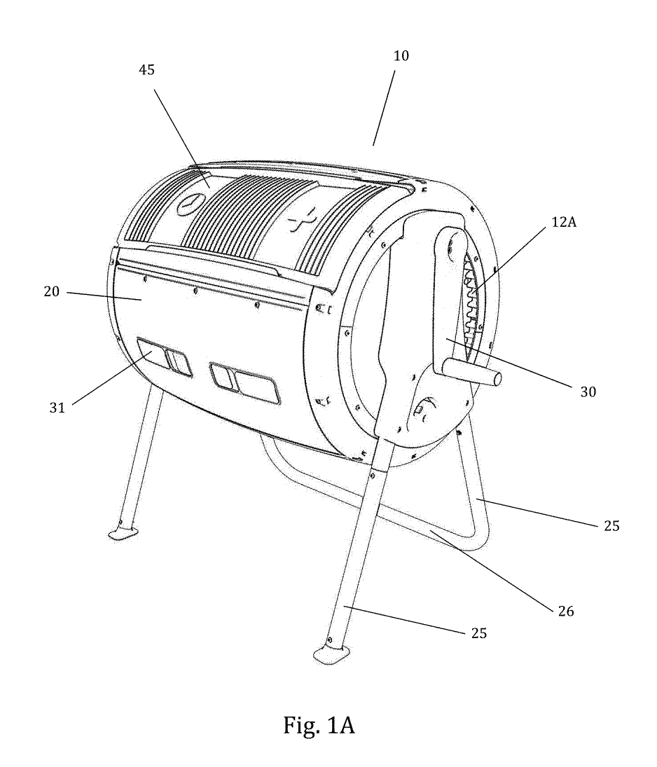

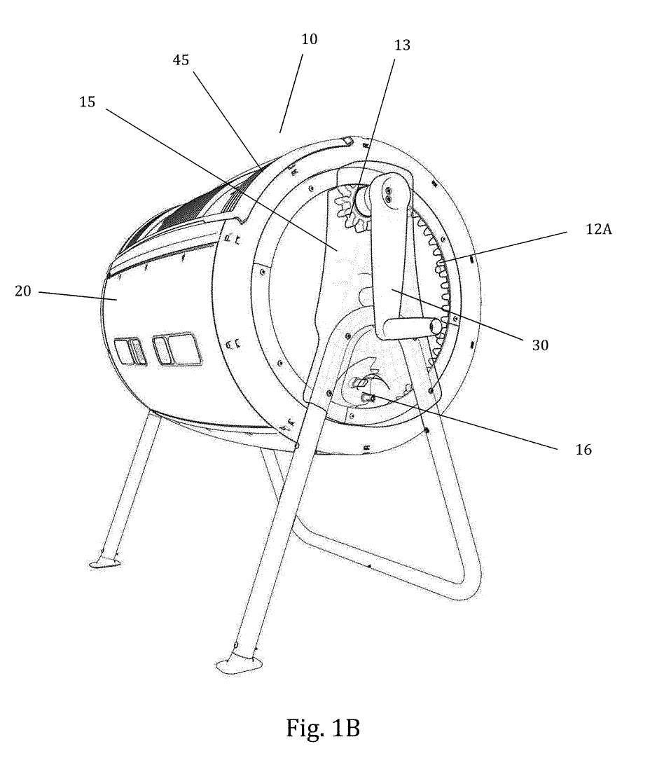

Referring to the drawings, FIG. 1A shows a composting apparatus in the form of a composter 10.

The composter 10 has a composting receptacle in the form of a barrel 20 which, in use, holds biodegradable matter until the same turns into compost. Typically, the biodegradable matter may include vegetable scraps and gardening waste, such as lawn clippings and leaves. The biodegradable matter is inserted into the barrel 20, and held in barrel until the matter degrades into compost, and this degrading process can take many weeks or months.

In the embodiment of FIG. 1A, the composting receptacle is in the form of a cylindrical barrel 20, however, the invention is not limited to this particular shape of composting receptacle. In other embodiments, the composting receptacle may be, for example, a longer or shorter cylinder, or may have a more or less pronounced curvature to the barrel sides. In other modifications, the end of the barrel, rather than having a circular cross-section, may be shaped with a triangular, square or other variant of the cross section.

### Rotation

The barrel 20 has an axis of rotation about which the barrel can be rotated. This ability to rotate the barrel 20 enables the contents of the barrel to be mixed and agitated, which enhances oxygenation of the contents to assist the composting process.

The barrel is provided with a rotation system in a form of a gear system which includes a mechanism and components 11 that combine to enable this rotation motion of the barrel.

the gear system is operable by a hand-operated crank having a handle 30. The user of the apparatus is able to rotate the barrel by turning the handle 30. The handle activates a gear system that allows rotation of the barrel. In other embodiments, the activation of rotation can be achieved by other mechanisms, such as a motor or by manual rotation of a wheel, rather than a crank handle.

### Stand

The barrel 20 is mounted on a stand assembly 25 which supports the barrel above ground level, so that the barrel is able to rotate without touching the ground.

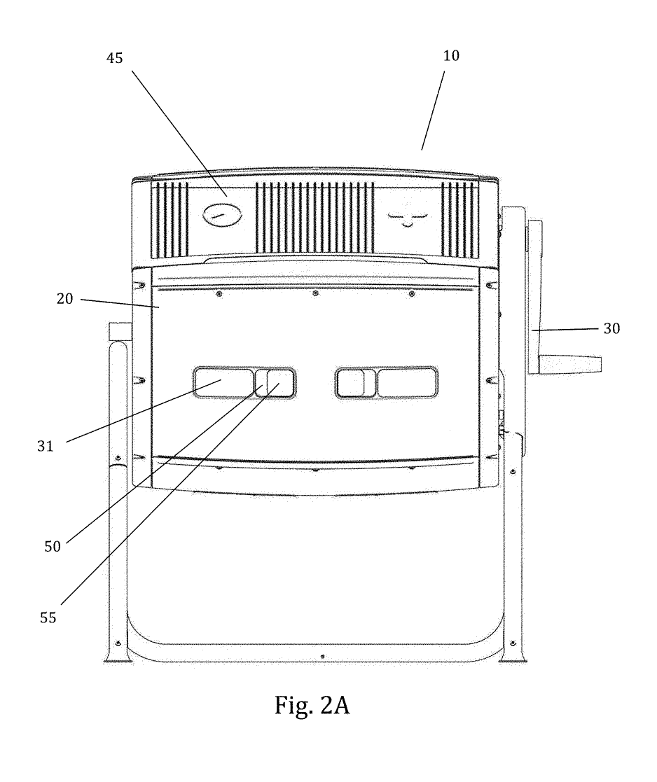

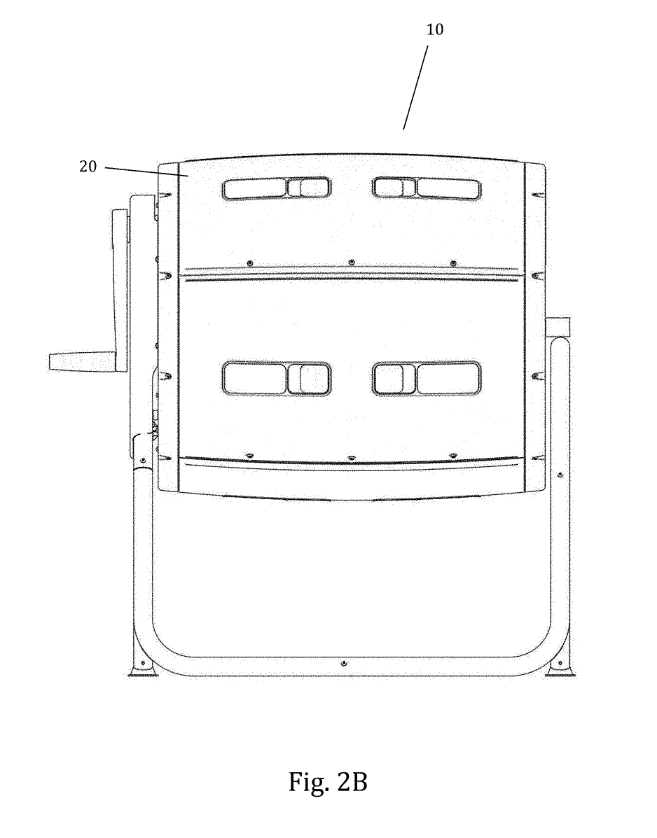

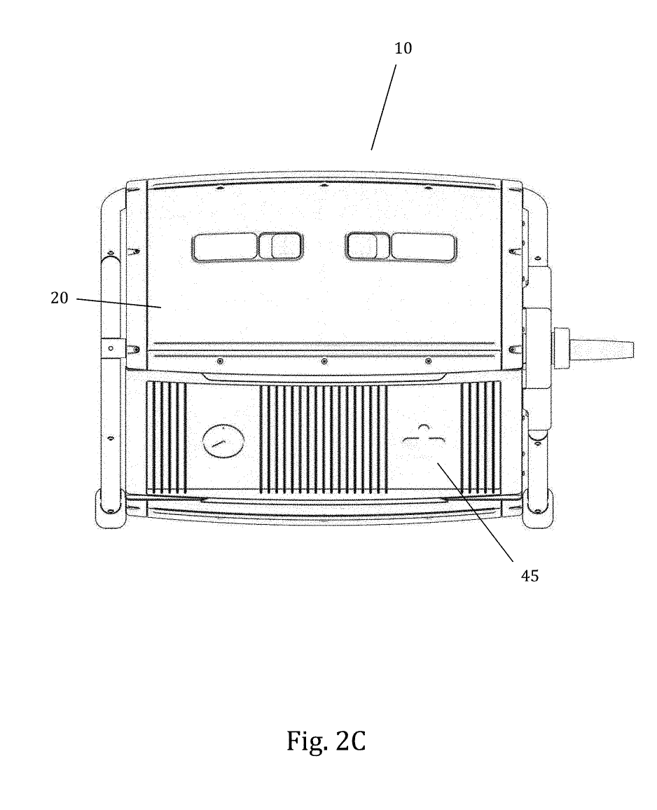

FIG. 2A is a front view of the embodiment of FIG. 1A shown in one particular orientation, bearing in mind that the barrel is able to rotate. Hence, it is understood that this is merely one possible rotational-orientation of the barrel.

FIG. 2B is a rear view of the orientation of FIG. 1A, once again bearing in mind that the barrel is able to rotate.

FIG. 2C is a top view of the orientation of FIG. 1A, once again bearing in mind that the barrel is able to rotate.

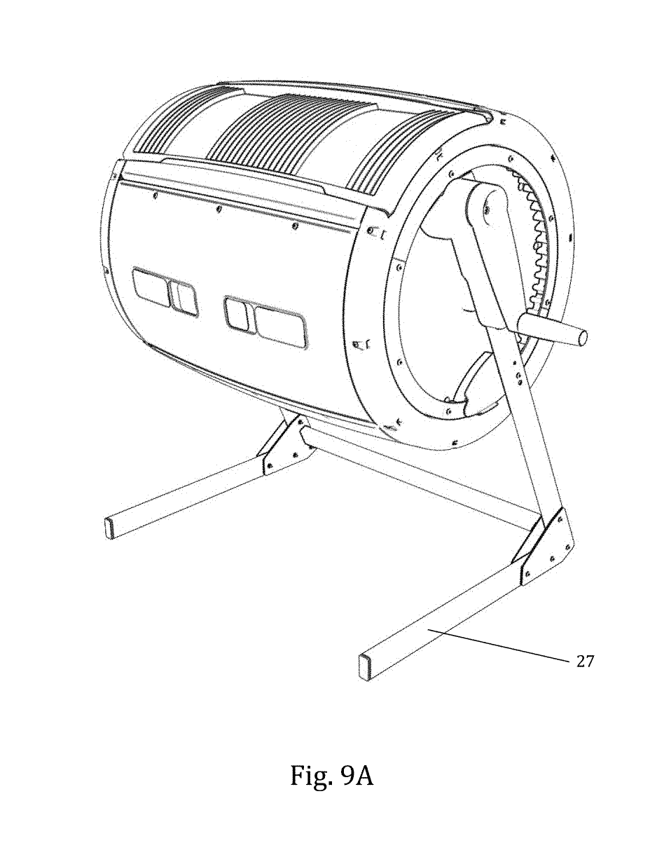

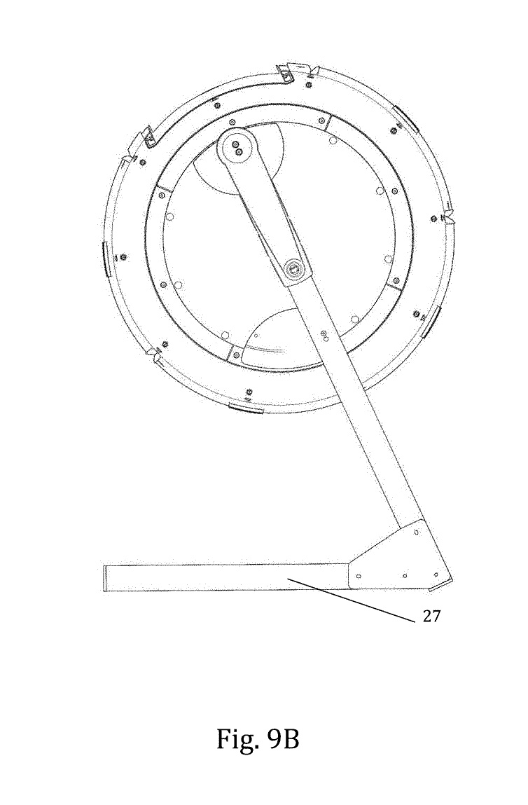

FIG. 9A is a perspective view of another embodiment of a composting apparatus having a modified stand assembly. FIG. 9B shows an end view of the embodiment of FIG. 9A, at the end that has a rotational handle, and showing the end view of the modified stand assembly.

Regarding the modified embodiment, the stand assembly of the modified embodiment includes an elbow portion 27 which, in use, is able to sit flat on flat ground surface. When the composter 10 is placed on a surface comprising soil, the elbow portion 27 that rests on the ground surface can minimizes the likelihood of the stand assembly sinking into soil.

### Handle for Rotation

The outer body of the barrel 20 is provided with handle-indentations 31 which provide an alternative means by which the user can rotate the barrel, but manually grasping the handle-indentations 31 to assist with the user rotating the barrel about its axis.

### Input and Output of Matter

The barrel 20 has at least one material-transit aperture through which the biodegradable matter is able to be either inserted into, and removed from the barrel as compost.

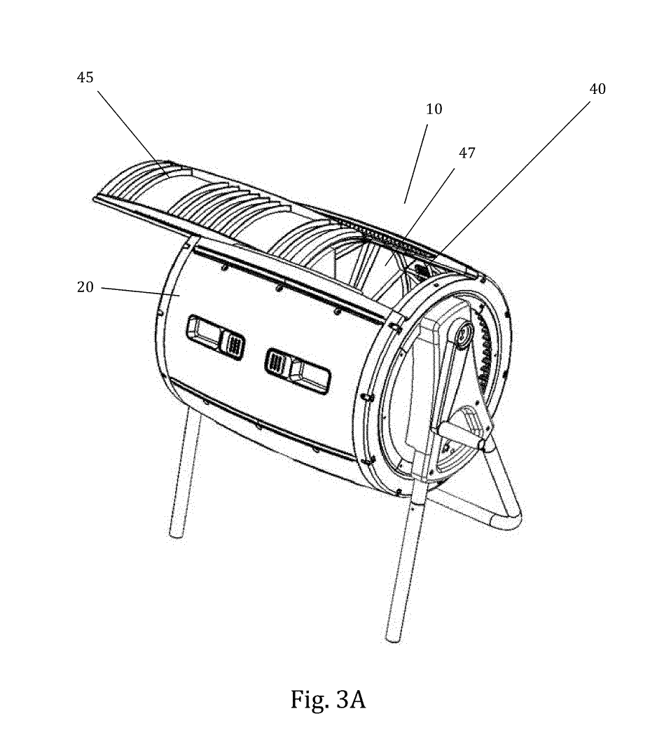

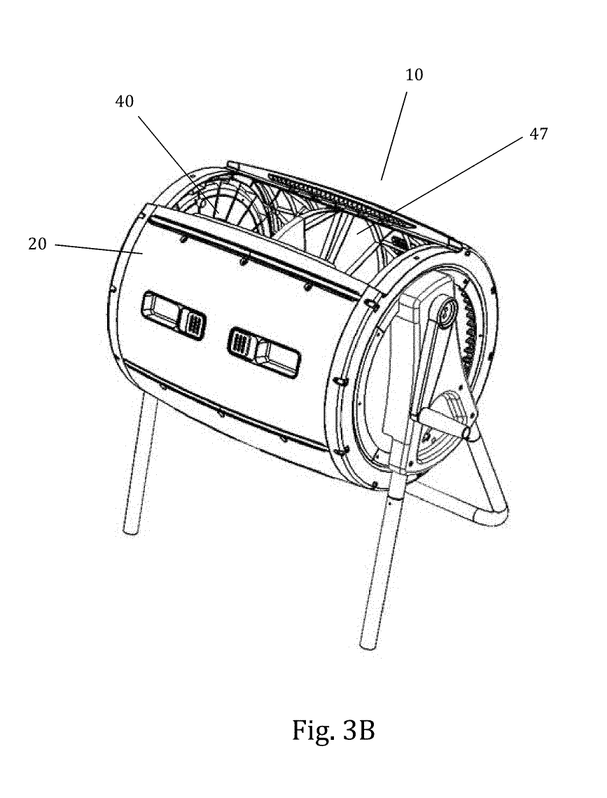

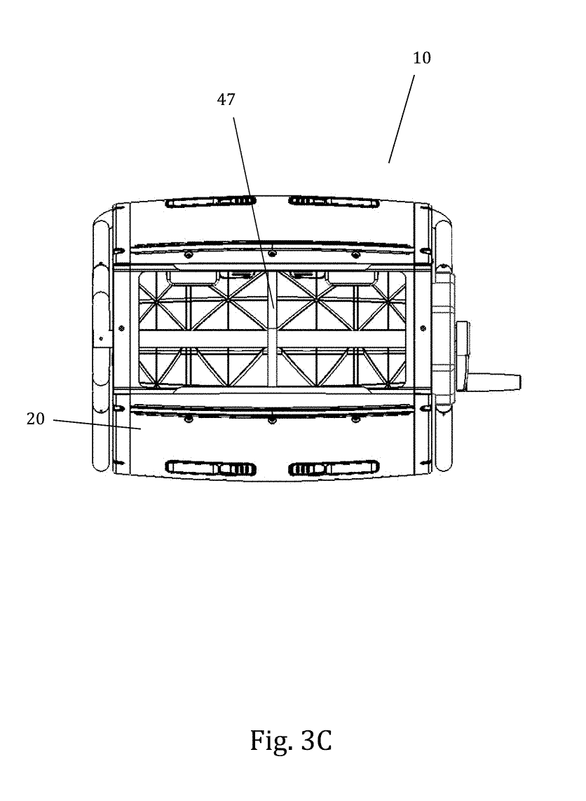

In FIG. 3A, the material-transit aperture is in the form of a door-apertures 40 that is closed by a retractable sliding cover in the form of a sliding door 45. The sliding door has longitudinal edges that can slide in corresponding grooves at the rim of the door entrance.

The sliding door can be completely slid out and removed from the grooves, and FIG. 3B shows the barrel 20 with the sliding door having been completely removed. FIG. 3C shows a top view of this configuration with the sliding door having been completely removed.

The abovementioned ability to rotate the barrel 20 also enables the at least one door-aperture 40 to be oriented in a position that makes it convenient for the insertion or removal of matter from the barrel. For example, for insertion of matter into the barrel, the door-aperture 40 can be oriented facing upwards (towards the sky). Whereas for removal of matter from the barrel, the door-aperture 40 can be oriented facing downwards (towards the ground). Alternatively, for removal of matter, the door-aperture 40 can be oriented facing upwards or side-facing such that the matter can be scooped out of the door-aperture.

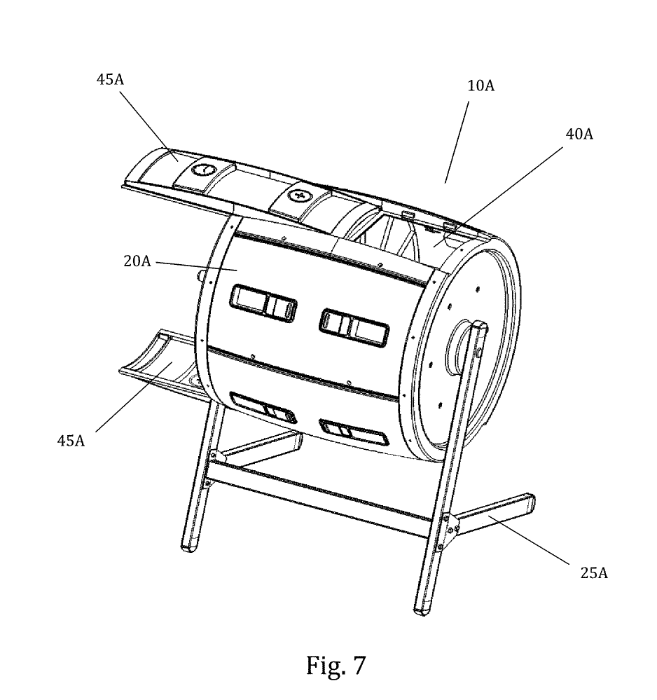

In a further embodiment, shown in FIG. 7, the barrel 20A can be provided with, for example, two door-apertures 40A, each having its own sliding door 45A. In this further embodiment, the user can push the matter by pressing through one of the door-apertures 40A, so as to cause the matter to exit the barrel out through the other of the two door-apertures 40A.

### Air Vents

The outer body of the barrel 20 is also provided with least one air-transit aperture through which the air is able to be enter the barrel, and gases produced by the composting process are able to escape from the barrel.

In FIG. 2A, the air-transit aperture is in the form of an air-aperture 50 that is closed by a tiny sliding door 55. Oxygen plays an important role in the composting process, and these one or more air-apertures 50 allow entrance of air into the interior of the barrel where the biodegradable matter is undergoing composting.

### Chamber Division

The interior of the barrel 20 provides at least one interior chamber in which the biodegradable matter is held for composting, however, the interior of the barrel can be provided with chamber-divider-means in the form of one or more partitions to create two or more sub-chambers. This partitioning may either be in the form of a permanent partition, or a removable partition.

The process of composting can take many months, and an advantage of having sub-chambers is that the composting process in each of the various chambers can be at different stages. In a single-chamber apparatus, the user has to wait till all the matter in the single chamber has been fully composted. In a typical situation where a user fills the composter with vegetable scraps and garden waste, it may take some time for the single chamber to be filled. Hence, for a single-chamber composter, the user has to wait till the most recent additions to the chamber have been composted before all the compost can be emptied for use.

Whereas, with multiple chambers, the user can progressively fill one chamber with new matter over a period of time, while the other full chamber can have compost ready for use sooner than having to wait for all of the newest matter in the apparatus to become composted as well.

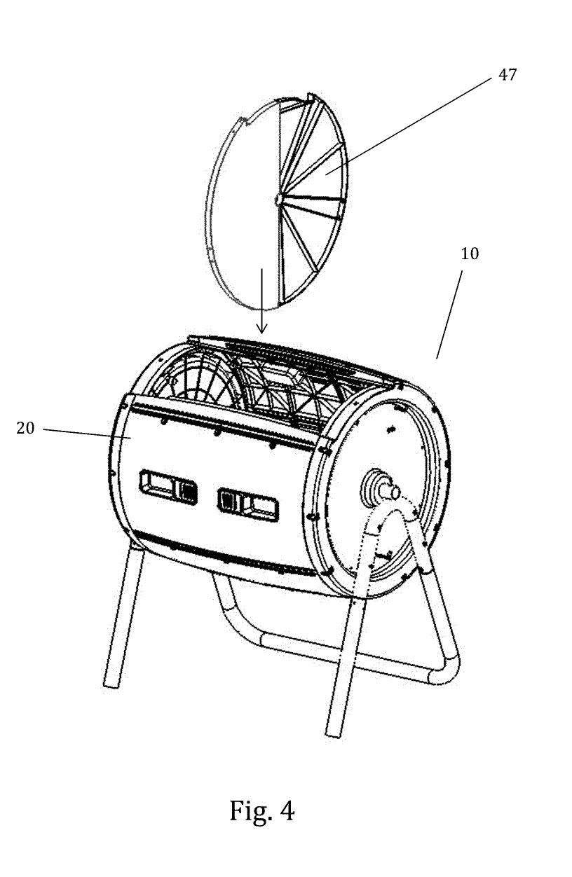

FIG. 4 is an exploded view which shows the embodiment of FIG. 1A with an internal partition that is adapted to divide the interior chamber of the barrel.

In FIG. 4, the chamber-divider-means is in the form of a generally circular partition 47. The actual shape of the partition 47 is adapted to conform to the interior contour of the interior of the barrel 20. The circular partition 47 is able to be slotted into a circumferential groove provided on the interior surface of the inner chamber of the barrel. Other modifications, for holding the partition 47 in place, may include pairs of positioning pins between which the partition 47 may be positioned. A number of possible mechanisms can be used to hold the partition 47 in place.

In the embodiment, the circular partition 47, once installed, can be removed by the user. So the user has the option of reverting to handling a large amount of biodegradable matter in one chamber if the user so desires.

In FIG. 3A, the sliding door 45 can be slid fully in both directions, and can be optionally slid away part of the way to reveal only one of the two sub-chambers, with the other sub-chamber being sealed by the other portion of the sliding door 45.

### Gears

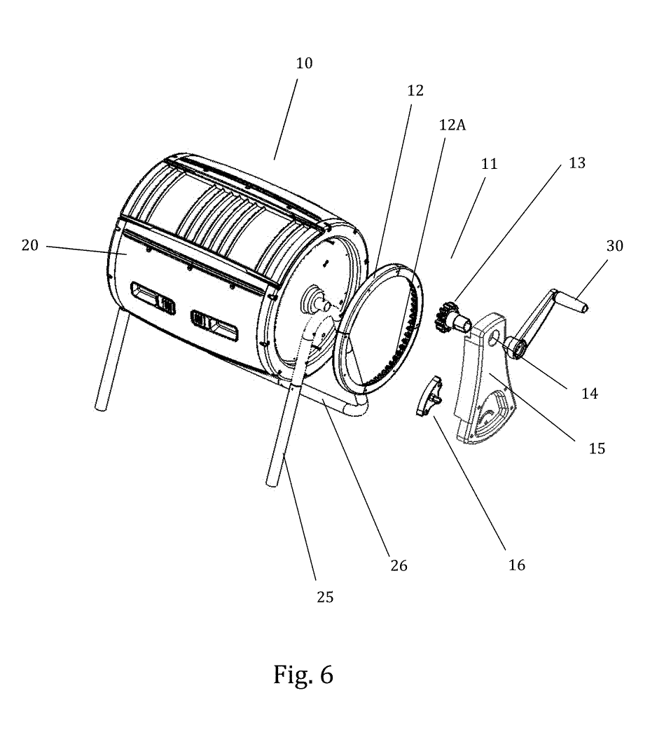

FIG. 6 shows an embodiment of the gear system 11 that enables the rotation motion of the barrel.

In FIG. 6, the gear system 11 includes a large ring 12 that is provided with an internal spur gear 12A. This large ring 12 is adapted to fit into a correspondingly-shaped circular depression of the end face of the barrel.

A small external spur gear 13 is adapted to mate with the internal spur gear of the large ring 12. The small external spur gear 13 is connected to the handle 30, such that rotation of the handle 30 causes the small external spur gear 13 to impart rotational movement to the large ring 12. That rotational movement from the gear system is thus transmitted to the barrel 20 causing it to rotate.

The small external spur gear 13 has an axle which is positioned in an axle hole 14. The axle hole 14 is located in a roughly triangular housing 15.

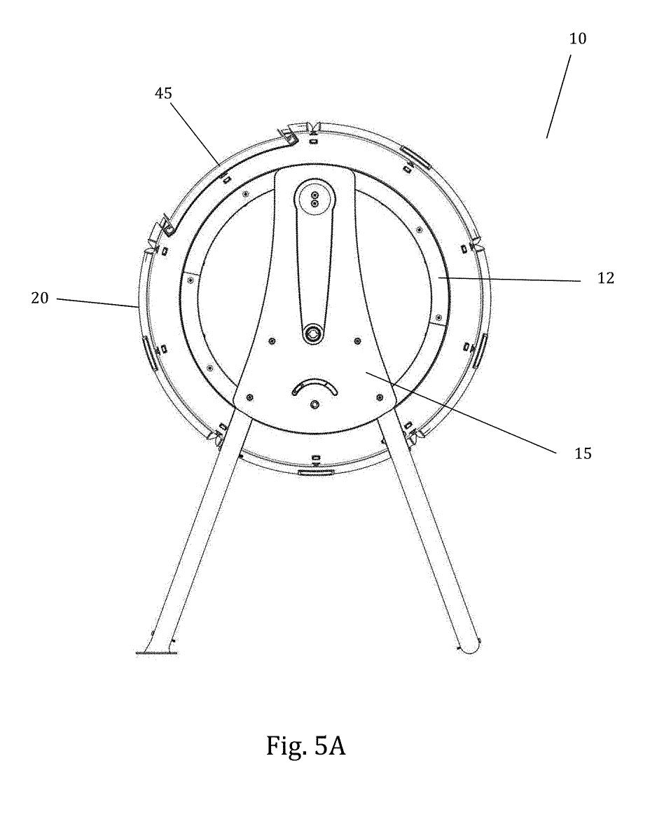

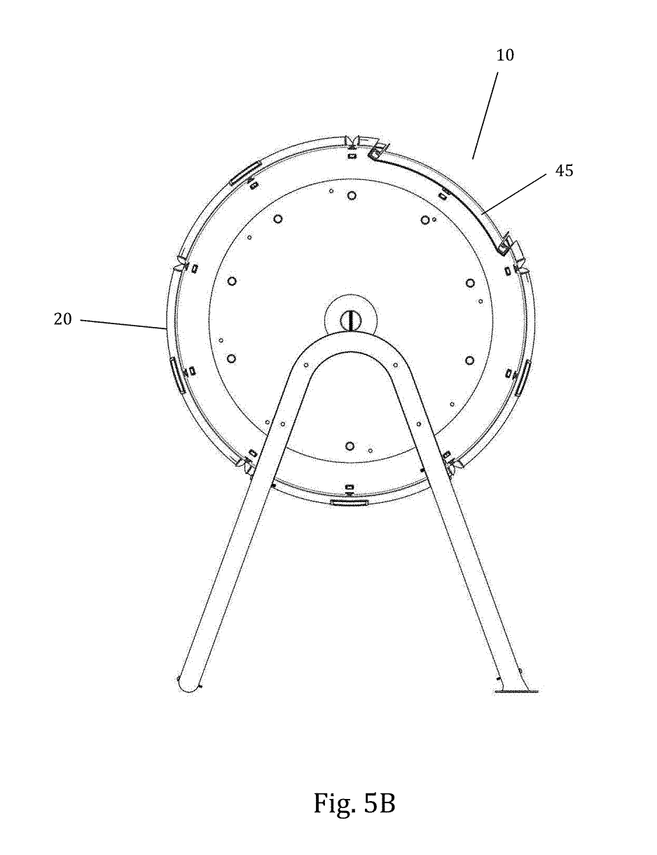

The housing 15 is able to be screwed onto the large ring 12, as shown in FIG. 5A.

The gear system 11 is provided with a ratchet 16 that enables the gear to only turn in one direction.

In other modifications, the ratchet can be disengaged to allow the user the option of having the barrel rotate in both a clockwise and anticlockwise direction.

In other modifications, the mechanism of the ratchet may be provided with a locking mechanism, so that the user can lock the ratchet in the configuration that corresponds to the user's desired manner for the working of the gear system, whether that be a single rotation or dual rotation.

In other modifications, the gear system may also be provided with a gear-immobilization-lock so that the user can lock the gear system in a particular orientation, for example, when the user needs to remove the compost from the barrel, in which instance it would be inconvenient for the barrel to be rotatable. For example, the gear-immobilization-lock may be in the form of an immovable device that meshes with the gear teeth, and prevents movement while the immovable device is so engaged with the gear. As another example, the gear-immobilization-lock may be in the form of a locking device that engages with the physical body of the barrel, such as a pin engaging with a hole in the barrel surface. The feature of the gear-immobilization-lock is not limited to a particular mechanism that can achieve the aim of locking the rotation of the barrel.

Embodiments of the invention can be initially manufactured and sold without the example of the gear system 11, and in such gear-less embodiments the user will rotate the barrel 20 using the handle-indentations 31. Such gear-less embodiments, sold without the gear system, are able to be retro-fitted with the gear system as an added accessory to existing devices according to this embodiment. Hence, the gear system is adapted to be installed on the composting apparatus being originally a gearless apparatus such that the composting apparatus is able to function and rotate with said gear system installed. The shape of the components, such as the large ring 12, are shaped to fit into the side of the barrel, so that the user can easily add the gear system as an accessory to the gear-less embodiment of the composter.

In the embodiment, the gears of the gear system are made of plastic material, although in other embodiments the gears can be made of metal.

### Trolley Combination

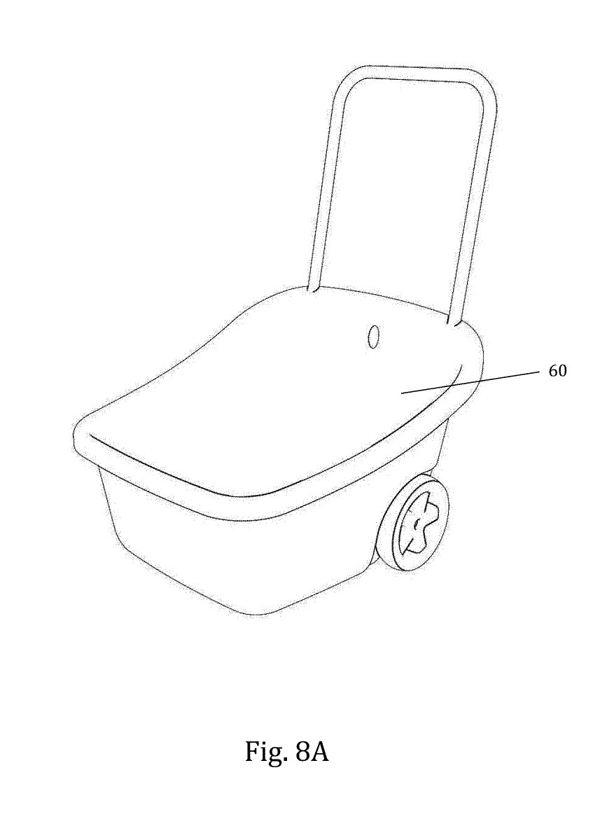

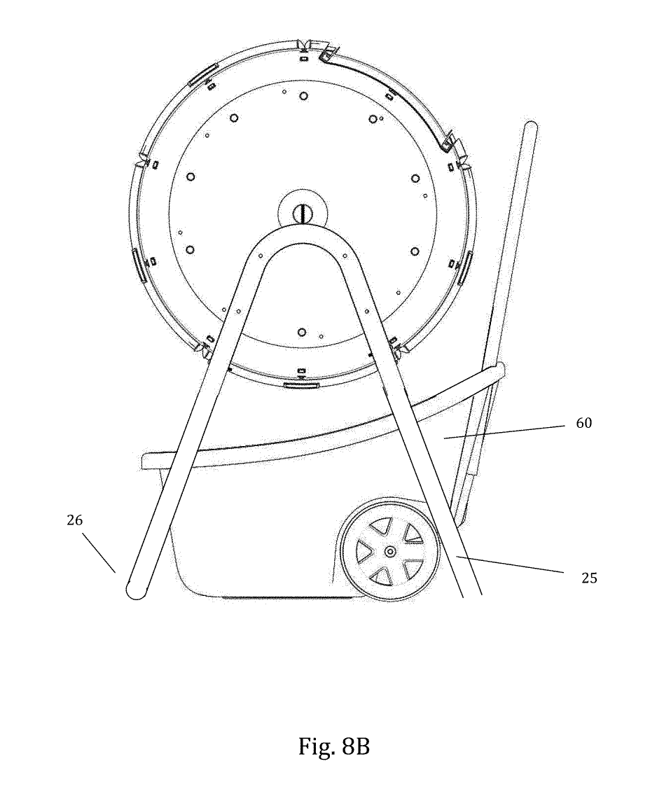

FIG. 8A shows a perspective view of an embodiment of a compost-transporter in the form of a trolley 60 that is adapted to be used in combination with the composter illustrated in FIG. 1A.

FIG. 8B shows a side view of the trolley of FIG. 8A used in combination with the composter illustrated in FIG. 1A. The trolley 60 is designed to be of such dimensions that it is adapted to fit in the gap that is underneath the barrel, when the barrel is supported by the stand 25. In use, the trolley is positioned underneath the barrel such that the compost removed from the barrel is able to fall directly into the trolley positioned below.

The barrel is provided with the stand 25 that is adapted to hold the barrel a distance above ground, and the composter 10 is further with the trolley 60 that is sized to fit in the space below the barrel in said distance between the barrel and the ground.

In FIG. 6, it can be seen that the stand assembly 25 is asymmetric, in that a connecting bar 26 is only provided on one side but not the other.

The further embodiment in FIG. 7 also has a variant of a stand assembly 25A which is also asymmetric, for the same reason of allowing a trolley to be positioned directly underneath the standing composter.

### OTHER EMBODIMENTS

The embodiments have been advanced by way of example only, and modifications are possible within the scope of the invention as defined by the appended claims.

For example, in a further embodiment, the composter is provided with a bag-support mechanism in the form of a hook for holding a bag that can accept waste material from the biodegradable matter. Often, the user will notice non-biodegradable items in the matter to be added to the composter, and the user is able to discard such non-biodegradable into a bag that is held and supported on the hook.

In this specification, where the words comprise or comprises or derivatives thereof are used in relation to elements, integers, steps or features, this is to indicate that those elements, integers, steps or features are present but it is not to be taken to preclude the possibility of other elements, integers, steps or features being present.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

In the present specification, terms such as “component”, “apparatus”, “means”, “device” and “member” may refer to singular or plural items and are terms intended to refer to a set of properties, functions or characteristics performed by one or more items having one or more parts. It is envisaged that where a “component”, “apparatus”, “means”, “device” or “member” or similar term is described as being a unitary object, then a functionally equivalent object having multiple components is considered to fall within the scope of the term, and similarly, where a “component”, “apparatus”, “assembly”, “means”, “device” or “member” is described as having multiple items, a functionally equivalent but unitary object is also considered to fall within the scope of the term, unless the contrary is expressly stated or the context requires otherwise.

It will be appreciated by those skilled in the art that many modifications and variations may be made to the embodiments described herein without departing from the spirit and scope of the invention.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the composting device, for example of FIG. 1A, being placed with the stand 25, 26 being on the ground.

What is claimed is:

1. A composting apparatus comprising:
a composting receptacle adapted to hold biodegradable matter until the matter turns into compost in the receptacle,
the composting receptacle having at least one aperture through which the biodegradable matter is able to be either inserted into or removed from the composting receptacle;
the composting receptacle adapted to rotate about an axis of rotation.

2. The composting apparatus of claim 1 wherein the composting receptacle is provided with one or more material-transit apertures through which the biodegradable matter is able to be either inserted into and removed from the composting receptacle as compost, and wherein each of said one or more one material-transit apertures is provided with a retractable sliding cover.

3. The composting apparatus of claim 1 wherein the composting receptacle has an interior chamber that is able to be divided into sub-chambers using chamber-divider-means to divide the interior chamber.

4. The composting apparatus of claim 2 wherein the composting receptacle has an interior chamber that is able to be divided into sub-chambers using chamber-divider-means to divide the interior chamber.

5. The composting apparatus of claim 3 wherein the composting receptacle is divided into at least two interior chambers, and the sliding cover is able to be slid away part of the way to reveal only one of the sub-chambers, with the other sub-chamber being sealed by the other portion of the sliding cover.

6. The composting apparatus of claim 4 wherein the composting receptacle is divided into at least two interior chambers, and the sliding cover is able to be slid away part of the way to reveal only one of the sub-chambers, with the other sub-chamber being sealed by the other portion of the sliding cover.

7. The composting apparatus of claim 1 wherein the composting receptacle is provided with a gear system that enables the rotation motion of the composting receptacle.

8. The composting apparatus of claim 7 wherein the gear system is adapted to be installed on the composting apparatus being originally a gearless apparatus such that the composting apparatus is able to function and rotate with said gear system installed.

9. The composting apparatus of claim 7 wherein the gear system is operable by a hand-operated crank.

10. The composting apparatus of claim 1 wherein the composting receptacle is provided with one or more air-transit apertures through which air is able to be enter the composting receptacle.

11. The composting apparatus of claim 2 wherein the composting receptacle is provided with one or more air-transit apertures through which air is able to be enter the composting receptacle.

12. The composting apparatus of claim 3 wherein the composting receptacle is provided with one or more air-transit apertures through which air is able to be enter the composting receptacle.

13. The composting apparatus of claim 4 wherein the composting receptacle is provided with one or more air-transit apertures through which air is able to be enter the composting receptacle.

14. The composting apparatus of claim 5 wherein the composting receptacle is provided with one or more air-transit apertures through which air is able to be enter the composting receptacle.

15. The composting apparatus of claim 6 wherein the composting receptacle is provided with one or more air-transit apertures through which air is able to be enter the composting receptacle.

16. The composting apparatus of claim 1 wherein the apparatus is provided with a bag-support mechanism for holding a bag that can accept waste material.

17. The composting apparatus of claim 1 wherein the composting receptacle is provided with a stand that is adapted to hold the composting receptacle a distance above ground, and the composting apparatus is further provided with a compost-transporter that is sized to fit in the space below the composting receptacle in said distance between the composting receptacle and the ground such that, in use, compost removed from the composting receptacle is able to fall directly into the compost-transporter positioned therebelow.

18. A composting system comprising the composting apparatus of claim 1 and a compost-transporter of such dimensions that the compost-transporter is adapted to fit in a gap that is underneath the composting receptacle when supported on a stand such that, in use, compost removed from the composting receptacle is able to fall directly into the compost-transporter positioned therebelow.
